(19) United States
(12) Patent Application Publication
(10) Pub. No.: US 2012/0148773 A1
(43) Pub. Date: Jun. 14, 2012

(54) Thermoset Ionomer Derivatives of Halogenated Polymers

(76) Inventors: J. Scott Parent, Kingston (CA); Ralph A. Whitney, Kingston (CA)

(21) Appl. No.: 13/316,174

(22) Filed: Dec. 9, 2011

Related U.S. Application Data
(60) Provisional application No. 61/421,489, filed on Dec. 9, 2010.

(51) Int. Cl. C08F 136/08; C08F 8/30; B32B 1/08; C08F 8/40; B01J 41/14; B32B 1/02

(52) U.S. Cl. 428/36.9; 525/333.1; 521/32; 428/35.7; 525/340; 525/375

(57) ABSTRACT

Nucleophilic substitution reactions of halogenated polymers and cross-linking nucleophiles are used to produce thermoset ionomers. These cured ionomers are useful in adhesive, antimicrobial applications, as well as in polymer composites and polymer blends. Furthermore, these thermoset ionomers' ion pairs can bear reactive functionality, which provides access to further reactions that were unavailable using previous technology.

### RELATED APPLICATION

This application claims the benefit of the filing date of U.S. Provisional Patent Application No. 61/421,489, filed on 9 Dec. 2010, the contents of which are incorporated herein by reference in their entirety.

### FIELD OF THE INVENTION

The present invention relates to cross-linked polymer compositions that include ionic functionality.

### BACKGROUND OF THE INVENTION

Poly(isobutylene-co-isoprene), (“IIR”), is a synthetic polymer commonly known as butyl rubber that has been prepared since the 1940's through random cationic copolymerization of isobutylene with small amounts of isoprene (1-2 mole %). As a result of its molecular structure, IIR possesses superior gas impermeability, excellent thermal stability, good resistance to ozone oxidation, exceptional dampening characteristics, and extended fatigue resistance.

Halogenated forms of IIR, which include brominated IIR (“BIIR”) and chlorinated IIR (“CIIR”) react more rapidly than unhalogenated forms when treated with standard nucleophilic reagents such as sulfur. The increased reactivity of halogenated IIR is due to the presence of allylic halide functionality, which is susceptible to nucleophilic substitution. Similarly, brominated poly(isobutylene-co-methylstyrene) (“BIMS”) is an elastomeric material that provides good air impermeability and oxidative resistance, as well as heightened reactivity to nucleophiles, owing to the benzylic halide functionality within the polymer.

Macromolecules having less than 5.0 mole % percent of ionic functionality, known herein as “ionomers”, are valued for their exceptional characteristics, which include a range of physical and chemical properties that are lacking in non-ionic analogues. Such characteristics include mechanical properties, adhesion to high surface energy solids (e.g., glass, metals), antimicrobial properties, and unusual solution viscosities. Since ionic functionalities are not effectively solvated by non-polar polyolefins, aggregation of polymer-bound ion pairs produces a non-covalent network of polymer chains. Presence of such networks contributes to improvements in mechanical properties such as strength and stiffness. Also, interaction of polymer-bound ion pairs with high surface energy solids (e.g., glass, metals) and polymer blend components enhances phase adhesion, thereby improving dispersion and compound reinforcement (J. S. Parent, A. Liskova, R. Resendes; Polymer 45, 8091-8096 (2004).

Ionomers have also been shown to provide antimicrobial properties that are lacking in polymers without ionic functionality (Y. Uemura, I. Moritake, S. Kurihara, T. Nonaka Journal of Applied Polymer Science (1999), 72(3), 371-378). As such, ionomer derivatives of halogenated polymers are valued in applications where surface anti-fouling and antibacterial activity are important.

Most commercially available ionomers are metal carboxylate or sulfonate salts of semi-crystalline thermoplastics. While these ionomers provide mechanical and adhesive properties discussed above, other properties such as creep and stress relaxation may be improved greatly by cross-linking to generate thermoset derivatives. In the case of amorphous elastomeric ionomers, cross-linking is required for most practical applications since in their uncured state, these rubbery ionomers exhibit excessive creep when subjected to a sustained load, owing to lability of ion-pair aggregates that give these materials strength. Cross-linking of polymer chains into a covalent network yields elastomeric thermosets with improved physical properties. Using existing technology, cross-linking is accomplished using reactions that operate on (i.e., form covalent bonds to) the polymer backbone, as opposed to operating on ionic functionality bound pendant to the backbone.

Therefore, there is a need for cross-linking nucleophiles that displace multiple halide leaving groups from a halogenated polymer to yield a thermoset ionomer that is stable to heat, moisture and chemical reagents. This vulcanized product would be produced in a single reaction, as opposed to sequential alkylation and cross-linking processes, thereby offering considerable reaction economy. Moreover, the resulting thermoset ionomer would provide good mechanical properties such as compression set resistance or flex fatigue, as well as superior adhesion or antimicrobial activity.

### SUMMARY OF THE INVENTION

An aspect of the invention provides a thermoset ionomer comprising a cross-linked network of polymer chains that are covalently bonded to one another by a plurality of pendant cationic moieties; wherein the cationic moieties comprise a bis-N-alkylated azolium ion, a moiety comprising a plurality of N-alkylated azolium ions, or a moiety comprising a plurality of P-alkylated phosphonium ions.

An embodiment of this aspect comprises a crosslinking imidazolium, as in formula (8):

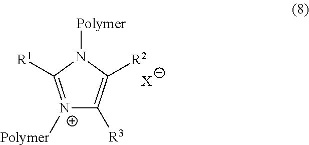

wherein R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality; optionally, any combination of R¹, R² and R³ together with the azole ring atoms to which they are bonded form a cyclic structure; and X⁻ is an anion. In certain embodiments, the imidazolium comprises imidazolium, 2-methylimidazolium, benzimidazolium, or a combination thereof.

An embodiment of this aspect provides a cross-linking pyrazolium, as in formula (9):

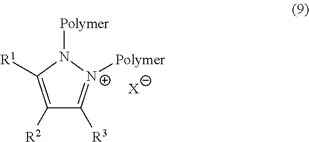

wherein R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality; optionally, any combination of R¹, R² and R³ together with the azole ring atoms to which they are bonded form a cyclic structure; and X⁻ is an anion. In some embodiments, the pyrazolium is pyrazolium, benzopyrazolium, or a combination thereof.

An embodiment of this aspect provides a crosslinking 1,2,3-triazolium, as in formula (10):

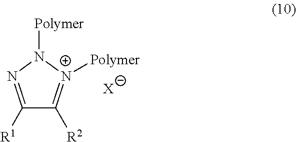

wherein R¹ and R² are independently hydrogen, silane, a substituted or unsubstituted C₁ to about C₁₆ aliphatic group, a substituted or unsubstituted C₁ to about C₁₆ aryl group, or a combination thereof, and optionally bear a functionality; optionally, R¹ and R² together with the azole ring atoms to which they are bonded form a cyclic structure; and X⁻ is an anion.

A further embodiment of this aspect provides a crosslinking 1,2,4-triazolium, as in formula (11):

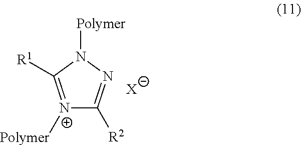

wherein R¹ and R² are independently hydrogen, silane, a substituted or unsubstituted to about C₁₆ aliphatic group, a substituted or unsubstituted C₁ to about C₁₆ aryl group, or a combination thereof, and optionally bear a functionality; optionally, R¹ and R² together with the azole ring atoms to which they are bonded form a cyclic structure; and X⁻ is an anion.

An embodiment of this aspect provides a plurality of N-alkylated moieties, as in formula (12):

(Polymer-Azolium)ₙ-Y(X⁻)ₙ (12)

where “azolium” is an imidazolium, a pyrazolium, an oxazolium, a thiazoliuim, a triazolium, or a combination thereof; X⁻ is an anion; n is an integer ranging from 2-300; and Y is a linker.

In some embodiments of this aspect, Y is an aliphatic linker. In certain embodiments, azolium is bis-alkylated 1,1′(1,4-butanediyl)bis(imidazole), as shown below:

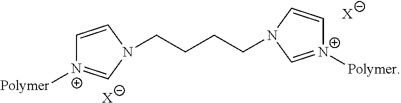

In some embodiments of this aspect, the cationic moiety comprises a plurality of imidazolium moieties bound to a polymer backbone. In some embodiments of this aspect, the thermoset polymer is a crosslinked network of isobutylene mers and imidazole-bearing mers, as shown below:

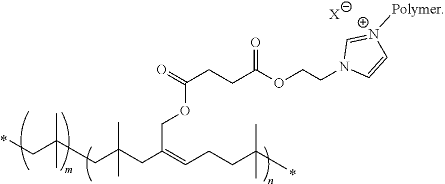

In certain embodiments of this aspect, comprising a plurality of alkylated moieties, as in formula (13)

(Polymer-Phosphonium)ₙ-Y(X⁻)ₙ (13)

where phosphonium is a quaternary phosphonium cation; n is an integer ranging from 2-10; and Y is a linker. In some embodiments, Y is aliphatic. In other embodiments, the phosphonium moieties are substituted where substituents may include aliphatic, aryl, or a combination thereof. In some embodiments of this aspect the cationic moieties comprise two diaryl phosphonium moieties linked by an aliphatic group. In some embodiments of this aspect the cationic moiety comprises bis-alkylated 1,2-bis(diphenylphosphino)ethane, as shown below:

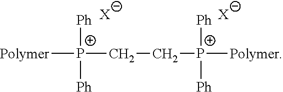

In some embodiments of this aspect the thermoset ionomer provides superior adhesion relative to a non-ionic analogue of the polymer. In some embodiments of this aspect the thermoset ionomer provides superior adhesion to glass, mylar, plastic, mineral, metal, ceramic, or a combination thereof. In certain embodiments of this aspect the thermoset ionomer reduces a population of organisms (e.g., bacteria, algae, fungi, mollusks, arthropods). In some embodiments of this aspect the thermoset ionomer prevent accumulations of organisms (e.g., bacteria, algae, fungi, mollusks, arthropods). In some embodiments of this aspect the organism comprises microorganism. In some embodiments of this aspect the microorganism is Gram-negative bacteria or Gram-positive bacteria. In some embodiments of this aspect the thermoset ionomer provides superior mechanical properties relative to a non-ionic analogue of the polymer. In one embodiment, the thermoset ionomer provides superior static properties or superior dynamic properties relative to a non-ionic analogue of the polymer. In another embodiment, the thermoset ionomer provides both superior static properties and superior dynamic properties relative to a non-ionic analogue of the polymer. The static property may be, for example, compression set resistance. The dynamic property may be, for example, flex fatigue.

An aspect of the invention provides a method of making thermoset ionomer, comprising mixing halogenated polymer and a cross-linking nucleophile, and heating the mixture to effect cross-linking, wherein the cross-linking nucleophile comprises an un-N-alkylated azole, a moiety comprising a plurality of un-N-alkylated azoles, or a moiety comprising a plurality of phosphines. In an embodiment of this aspect the cross-linking nucleophile is azole, bisazole, or bisphosphine.

In another embodiment of this aspect, the azole is an imidazole of formula (1):

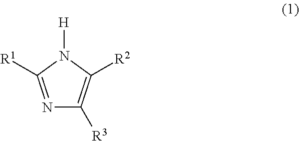

wherein R¹, R² and R³ are independently hydrogen, silane, a substituted or unsubstituted C₁ to about C₁₆ aliphatic group, a substituted or unsubstituted C₁ to about C₁ aryl group, or a combination thereof, and optionally bear a functionality; and optionally, any combination of R¹, R² and R³ together with the azole ring atoms to which they are bonded form a cyclic structure. In yet another embodiment of this aspect, the imidazole is imidazole, 2-methylimidazole, benzimidazole, or a combination thereof.

In another embodiment of this aspect, the azole is a pyrazole of formula (2):

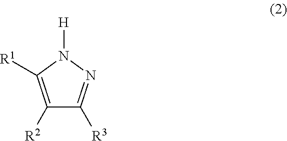

wherein R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality; and optionally, any combination of R¹, R² and R³ together with the azole ring atoms to which they are bonded form a cyclic structure. In another embodiment of this aspect, the pyrazole is pyrazole, benzopyrazole, or a combination thereof.

In another embodiment of this aspect, the cross-linking nucleophile is a triazole of formula (3) or formula (4):

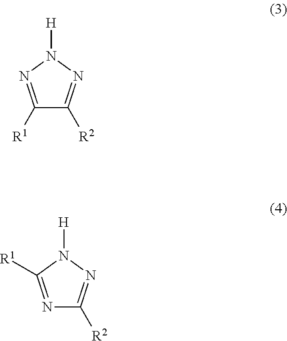

where R¹ and R² are independently hydrogen, silane, a substituted or unsubstituted C₁ to about C₁₆ aliphatic group, a substituted or unsubstituted C₁ to about C₁₆ aryl group, or a combination thereof, and optionally bear a functionality; and optionally, R¹ and R² together with the azole ring atoms to which they are bonded form a cyclic structure.

In another embodiment of this aspect, the cross-linking nucleophile is a compound of formula (5):

(Azole)ₙ-Y (5)

wherein “Azole” is an imidazole, a pyrazole, an oxazole, a thiazole, a triazole, or mixtures thereof; n is an integer ranging from 2-300; and Y is a linker.

In another embodiment of this aspect, the cross-linking nucleophile comprises two imidazole moieties linked by an aliphatic linker. In another embodiment of this aspect, the cross-linking nucleophile comprises 1,1′(1,4-butanediyl)bis(imidazole), as shown below.

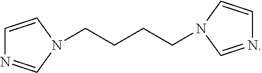

In another embodiment of this aspect, the crosslinking nucleophile comprises a plurality of imidazole moieties bound to a polymer backbone. In another embodiment of this aspect, the cross-linking nucleophile comprises a copolymer of isobutylene mers and imidazole-bearing mers, as shown below:

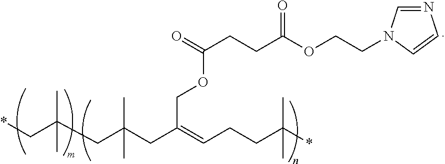

In certain embodiments of this aspect, the cross-linking nucleophile is a compound of formula (6):

(R₁R₂P)ₙ—Y (6)

where R₁ and R₂ are independently substituted or unsubstituted aryl groups, substituted or unsubstituted aliphatic groups, or a combination thereof, and optionally bear a functionality; n is an integer ranging from 2-10; and Y is a linking moiety.

In another embodiment of this aspect, the cross-linking nucleophile comprises a plurality of phosphine moieties bound to a linker. In another embodiment of this aspect, the phosphine moieties are substituted. In another embodiment of this aspect, the substituents are aliphatic, aryl, or a combination thereof. In another embodiment of this aspect, the phosphine moieties comprise two diaryl phosphine moieties linked by an aliphatic group. In another embodiment of this aspect, the cross-linking nucleophile comprises 1,2-bis(diphenylphosphino)ethane, 1,6-bis(diphenylphosphino)hexane, or a combination thereof. In another embodiment of this aspect, the halogenated polymer comprises BIIR, CIIR, BIMS, chlorinated polyethylene, halogenated EPDM (ethylene propylene diene monomer), or a combination thereof. In certain embodiment of this aspect, filler is added to the mixture. In embodiments of this aspect, the filler comprises carbon black, silica, clay, glass fibres, polymeric fibres, finely divided minerals, or a combination thereof. Other embodiments of this aspect, add other additives to the mixture.

In embodiments of this aspect, the other additive is antioxidant, wax, reinforcing filler, non-reinforcing filler, ultraviolet radiation stabilizer, anti-ozone-stabilizing compound, tackifier, oil, soap, or a combination thereof. In embodiments of this aspect, the antioxidant comprises a phenolic or an amine.

Certain embodiments of the method of making the thermoset ionomer, further comprise solvent. In some embodiments, the solvent is hexane, toluene, THF, dichloromethane, chloroform, or a combination thereof. In embodiments with solvent, the thermoset ionomer is a gel.

Another aspect of the invention provides a kit comprise a first container housing halogenated polymer; a second container housing a crosslinking nucleophile selected from a phosphine or an azole having at least one protonated nitrogen in the azole ring; and instructions comprising directions to mix halogenated polymer and the crosslinking nucleophile and incubate at an appropriate temperature to form a crosslinked polymer.

In certain embodiments of this aspect, the azole is a compound of formula (1), a compound of formula (2), or a compound of formula (3) or (4). In certain embodiments of this aspect, the halogenated polymer comprises BIIR, CIIR, BIMS, chlorinated polyethylene, halogenated EPDM (ethylene propylene diene monomer), or a combination thereof. Some embodiments of this aspect, further comprise filler. In certain embodiments of this aspect, the filler is housed in the first container. In certain embodiments of this aspect, the filler comprises carbon black, silica, clay, glass fibres, polymeric fibres, finely divided minerals, or a combination thereof. In certain embodiments of this aspect, the kit further comprise a third container which is a mold used during formation of crosslinked polymer. In certain embodiments of this aspect, the instructions comprise printed material, text or symbols provided on an electronic-readable medium, directions to a web site, or electronic mail.

In another aspect the invention provides an article comprising a thermoset ionomer of any one of the preceding aspects. In embodiments of this aspect the article provides superior adhesion relative to a non-ionic analogue of the polymer. In embodiments of this aspect the article provides superior adhesion to glass, mylar, plastic, mineral, metal, ceramic, or a combination thereof. In embodiments of this aspect the article reduces a population of organisms (e.g., bacteria, algae, fungi, mollusks, or arthropods). In embodiments of this aspect the article prevents accumulations of organisms (e.g., bacteria, algae, fungi, mollusks, or arthropods). In some embodiments of this aspect the organism comprises microorganism. In some embodiments of this aspect the organism comprises microorganism, wherein the microorganism is Gram-negative bacteria or Gram-positive bacteria. In embodiments of this aspect, the article provides superior mechanical properties relative to an article comprising a non-ionic analogue of the polymer. In one embodiment, the article provides superior static properties or superior dynamic properties. In another embodiment, the article provides both superior static properties and superior dynamic properties. The static property, may be, for example, compression set resistance. The dynamic property may be, for example, flex fatigue.

Embodiments of this aspect include: fuel cell membrane, pharmaceutical stopper, syringe fitting, ion-exchange resin, separation membrane, bathroom safety equipment, garden equipment, spa equipment, water filtration equipment, caulking, sealant, grout, contact cement, adhesive, pressure sensitive adhesive, tank liner, membrane, packaging material, cell culture equipment, light switch, exercise equipment, railing, sports equipment, steering wheel, writing tool, luggage, o-ring, tire inner liner, tire tread, thermoplastic vulcanizate (TPV), gasket, appliance, baby product, bottle, lid, toilet seat, bathroom fixture, flooring, surface including surface for food preparation, utensil, handle, grip, doorknob, container for food storage, gardening tool, kitchen fixture, kitchen product, office product, pet product, water storage equipment, food preparation equipment, shopping cart, surfacing material, storage container including food storage container, footwear, protective wear, sporting gear, cart, dental equipment, door knob, clothing, handheld device, telephone, toy, container for fluid, catheter, keyboard, surface of vessel, surface of pipe, surface of duct, coating, food processing equipment, materials handling equipment (e.g., auger, conveyor belt), biomedical device, filter, additive, computer, dock, drilling platform, ship hull, underwater infrastructure, HVAC equipment, shower wall, shower flooring, implant, medical textile, tissue sealant, tissue adhesive, personal protective equipment, wetsuit, drysuit, respiratory mask, article to minimize biofouling, pacemaker, wound dressing, ice machine, water cooler, fruit juice dispenser, soft drink machine, piping, storage vessel, metering system, valve, fitting, attachment, filter housing, lining, barrier coating, insulation, chemical protective equipment, or biochemical protective equipment.

In another aspect the invention provides a thermoset ionomer comprising a crosslinked mixture obtained by the above aspect of the method of making thermoset ionomer.

Another aspect of the invention provides use of thermoset ionomers described herein. In some embodiments, the use of the thermoset ionomers provides a reduction in a population of organisms (e.g., bacteria, algae, fungi, mollusks, or arthropods). In some embodiments the use of the thermoset ionomers prevents accumulations of organisms (e.g., bacteria, algae, fungi, mollusks, or arthropods).

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 is a schematic showing a synthetic methodology used to prepare a thermoset ionomer derivative of BIIR by bisalkylation of imidazole with the allylic bromide functionality within the halogenated polymer.

FIG. 2 is a plot of the storage modulus versus time for mixtures of BIIR+imidazole+Proton Sponge.

FIG. 3 is a plot of the storage modulus versus time for a mixture of BIMS+imidazole.

FIG. 4 is a plot of the storage modulus versus time for a mixture of BIIR+1,1′(1,4-butanediyl)bis(imidazole).

FIG. 5 is a plot of the storage modulus versus time for a mixture BIIR+1,2-bis(diphenylphosphino)ethane.

FIG. 6 is a plot of the storage modulus versus time for a mixture of BIIR+Imidazole-functionalized butyl rubber.

### DETAILED DESCRIPTION OF THE INVENTION

Aspects of the present invention include thermoset ionomers derived from halogenated polymers and cross-linking nucleophiles. Other aspects of the present invention include methods of preparing such products. The following terms will be used in the description of these aspects.

### DEFINITIONS

As used herein, “aliphatic” is intended to encompass saturated or unsaturated hydrocarbon moieties that are straight chain, branched or cyclic and, further, the aliphatic moiety may be substituted or unsubstituted.

As used herein, “aryl” is intended to encompass aromatic ring moieties that are typically five or six membered rings. Aryl includes heteroaryl. Large aryl moieties such as “a C12 aryl group” are intended to encompass fused ring systems.

As used herein, the term “azole” is a cyclic five-membered heteroaromatic compound having one nitrogen atom and at least one other non-carbon atom of either nitrogen, sulfur, or oxygen. Examples of azoles described herein include imidazoles, pyrazoles, oxazoles, thiazoles, and triazoles.

As used herein, the term “azolium ionomer” “refers to polymer compositions comprising a polymer backbone and a plurality of azolium cations that are covalently-bound to the backbone in a pendant position.

As used herein, the term “bis-N-alkylated” refers to the condition of an azolium ion, in which two nitrogen atoms within the ring are covalently bonded to respective macromolecular substituents.

As used herein, the term “IIR” means poly(isobutylene-co-isoprene), which is a synthetic elastomer commonly known as butyl rubber. As used herein, the term “BIIR” means brominated butyl rubber. As used herein, the term “CIIR” means chlorinated butyl rubber.

As used herein, the term “BIMS” means brominated poly(isobutylene-co-methylstyrene).

As used herein, the term “cross-linking nucleophile” means a compound that reacts with a halogenated polymer to yield a thermoset ionomer derivative.

As used herein, the terms “curing”, “vulcanizing”, or “cross-linking” are used interchangeably and refer to formation of covalent bonds that link one polymer chain to another, thereby altering the properties of the material.

As used herein, the term “functionality” is a chemical moiety that does not displace halide from a halogenated polymer during an ionomer synthesis, but rather performs a function following ionomer preparation. For example, a pendant group on an polymer that includes an —Si(OMe)₃ moiety can perform the function of binding to siliceous fillers. Alternately, a pendant group on a polymer that includes C═C unsaturation can perform the function of peroxide-initiated cross-linking. Non-limiting examples of functionalities include: silane, alkoxysilane, siloxane, alcohol, epoxide, ether, carbonyl, carboxylic acid, carboxylate, aldehyde, ester, anhydride, carbonate, tertiary amine, imine, amide, carbamate, urea, maleimide, nitrile, olefin, acrylate, methacrylate, itaconate, styrenic, borane, borate, thiol, thioether, sulfate, sulfonate, sulfonium, sulfite, thioester, dithioester, halogen, peroxide, hydroperoxide, phosphate, phosphonate, phosphine, phosphate, phosphonium, alkyl, and aryl.

As used herein, the term “halogenated polymer” means a polymer that includes a halogen-carbon electrophile that is reactive toward nitrogen nucleophiles.

As used herein, the term “heteroatom” refers to a non-carbon atom such as, for example, nitrogen, sulphur, oxygen.

As used herein, the term “ionic” refers to presence of charged moieties.

As used herein, the term “ionomer” refers to a macromolecule having less than 5.0 mole percent ionic functionality.

As used herein, the term “macromolecular substituent” refers to polymer chains covalently bonded to azolium and phosphonium ions via, for example, alkyl groups, allyl groups, and benzylic groups.

As used herein, the term “moisture-generating component” is a compound that releases water upon heating and, although the released water participates in reactions, the remainder of the moisture-generating component is either non-reactive or does not inhibit reactions that lead to crosslinks between polymers.

As used herein, the term “N-alkylated” refers to the condition of an azolium ion, in which a nitrogen atom within the ring is covalently bonded to a macromolecular substituent.

As used herein, the term “N-nucleophile” refers to a compound comprising nitrogen bearing a lone pair of electrons that undergoes a nucleophilic substitution reaction at an electrophilic site. This may occur, for example, at an allylic or benzyllic site of a halogenated elastomer.

As used herein, the term “nucleophilic substitution” refers to displacement of a halide by a nucleophilic reagent and includes N-alkylation of azoles, phosphines and the like.

As used herein, the terms “polymer backbone” and “main chain” mean the main chain of a polymer to which pendant group is attached. As used is structures shown herein, a connection to “Polymer” is not meant to be limiting, and may, for example, be an indirect or a direct bond to polymer backbone.

As used herein, the term “P-alkylated” refers to the condition of a phosphonium ion, in which the phosphorus atom is covalently bonded to a macromolecular substituent.

As used herein the term “Proton Sponge” refers to 1,8-bis(dimethylamino)naphthalene.

As used herein “substituted” refers to the structure having one or more substituents. A substituent is an atom or group of bonded atoms that can be considered to have replaced one or more hydrogen atoms attached to a parent molecular entity. A substituent can be further substituted. In preferred embodiments, substituents are selected to perform a function.

As used herein, the term “thermoset ionomer” refers to cross-linked polymer compositions comprising a polymer backbone and a plurality of covalently-bound cations.

A “trigger” is a change of conditions (e.g., introduction of water, change in temperature) that begins a chemical reaction or a series of chemical reactions.

### DESCRIPTION

Poly(isobutylene-co-isoprene), (“butyl rubber” or “IIR”), is an elastomeric random copolymer comprised of isobutylene and small amounts of isoprene (1-3 mole %). Halogenated forms of IIR, which include brominated IIR (“BIIR”) and chlorinated IIR (“CIIR”) react more rapidly than unhalogenated forms when treated with standard nucleophilic reagents such as sulfur. The increased reactivity of halogenated IIR is due to the presence of electrophilic allylic halide functionality, which is susceptible to nucleophilic substitution. Similarly, brominated poly(isobutylene-co-methylstyrene) (“BIMS”) is an elastomeric material that provides good air impermeability and oxidative resistance, as well as heightened reactivity to nucleophiles, owing to electrophilic benzylic halide functionality within the polymer.

Isobutylene-rich elastomeric ionomers have been prepared by nucleophilic displacement of halide from BIIR by triphenylphosphine to yield quaternary phosphonium bromide ionomers (J. S. Parent, A. Penciu, S. A. Guillen-Castellanos, A. Liskova, R. A. Whitney, (2004) Macromolecules 37: 7477-7483). Quaternary phosphonium salts have been similarly prepared by reaction of BIMS with triphenylphosphine (P. Arjunan, H. C. Wang, (1997) Polymer Material Science and Engineering 76: 310-311). These ionomers have a plurality of ion pairs located pendant to the polymer backbone, each having the generic structure illustrated below.

Polymer-P\hat{⁺}Ph₃X\hat{⁻}

A deficiency of phosphine-based chemistry is the limited range of air-stable, functional phosphines that are suitable for producing IIR-derived ionomers. Other than air-stable triphenylphosphine, which bears unreactive phenyl substituents, inexpensive phosphines that are air-stable and that bear useful reactive functionalities are not commercially (i.e., readily) available, and must therefore be prepared at great expense.

Inexpensive tertiary amines are much more abundant, and are available with a wide range of chemical functionality. They have been used to prepare quaternary ammonium bromide derivatives of BIIR (J. S. Parent, A. Liskova, R. A. Whitney and R. Resendes (2005) Journal of Polymer Science—Part A: Polymer Chemistry 43: 5671-5679) and of BIMS (A. H. Tsou, I. Duvdevani, P. K. Agarwal; Polymer 45, 3163-3173, 2004). These ionomers have pendant ion pairs of the generic structure illustrated below.

Polymer-N\hat{⁺}R¹R²R³X\hat{⁻}

The thermal instability of such N-alkylation products requires the use of excess nucleophile to drive reactions of halogenated polymers and tertiary amines toward the desired ionomer. In the absence of excess amine, ammonium halide ion pairs are unstable. However, when excess amine is present, the resulting ionomeric product has an undesirable odour (e.g., fishy smell), discolouration and certain toxicological problems.

Other nucleophilic nitrogen compounds have been examined in the context of ionomer formation. Pyridines have been reacted with BIIR and CIIR in a solution process to produce ionomers that do not bear reactive functionality, but provide good tensile properties (I. Kuntz, R. Park, F. P. Baldwin; U.S. Pat. No. 3,011,996 (1961)). Similar to the quaternary ammonium ionomer syntheses described above, a large excess of pyridine is required along with long reaction times to produce the desired ion pair. When excess pyridine is present, the resulting ionomeric product has an undesirable odour, and certain toxicological problems.

Amidines, imines and oxazolines have also been examined as potential nitrogen nucleophiles for the synthesis of ionomers (M. Faba, M. Sc. Thesis, Queen's University, Kingston, Ontario, Canada (2010)). While these reagents can be N-alkylated by halogenated polymers to give ionomer intermediates, resulting ion pairs are highly sensitive to water. Hydrolysis of the ion pair leads to a loss of the desirable ionomer properties described above. Accordingly, using previously known technology, it was not possible to prepare a thermoset ionomer by a single reaction between a cross-linking nucleophile and a halogenated polymer to yield stable ion pairs.

Surprisingly, it has been discovered that reactions of halogenated polymers with select azoles, bisazoles and bisphosphines yields thermally and chemically stable azolium halide ion pairs that serve as covalent cross-links between polymer chains, thereby providing a thermoset polymer composition. In the following description, halogenated polymers of the invention, cross-linking nucleophiles of the invention, other additives, methods of preparing thermoset ionomers, and properties of thermoset ionomers are described.

### Halogenated Polymer

“Halogenated polymer” as used herein includes polymers having non-electrophilic mers that do not react with the cross-linking nucleophile described herein, and halogen-comprising electrophiles that react with nitrogen nucleophiles. The non-electrophilic mer composition within a halogenated polymer is not particularly restricted, and may comprise any polymerized olefin monomer. As used herein, the term “olefin monomer” is intended to have a broad meaning and encompasses α-olefin monomers, diolefin monomers and polymerizable monomers comprising at least one olefin linkage.

In certain embodiments, the olefin monomer is an α-olefin monomer. α-Olefin monomers are well known in the art and the choice thereof for use in the present process is within the purview of a person skilled in the art. Preferably, α-olefin monomers of the invention include isobutylene, ethylene, propylene, 1-butene, 1-pentene, 1-hexene, 1-octene, and branched isomers thereof. Other preferred α-olefin monomers of the invention include styrene, α-methylstyrene, para-methylstyrene, and combinations thereof. Particularly preferred α-olefin monomers include isobutylene and para-methylstyrene.

In other embodiments, the olefin monomer comprises a diolefin monomer. Diolefin monomers are well known in the art and the choice thereof for use in the present process is within the purview of a person skilled in the art. Non limiting examples of suitable diolefin monomers include: 1,3-butadiene; isoprene; divinyl benzene; 2-chloro-1,3-butadiene; 2,3-dimethyl-1,3-butadiene; 2-ethyl-1,3-butadiene; piperylene; myrcene; allene; 1,2-butadiene; 1,4,9-decatrienes; 1,4-hexadiene; 1,6-octadiene; 1,5-hexadiene; 4-methyl-1,4-hexadiene; 5-methyl-1,4-hexadiene; 7-methyl-1,6-octadiene; phenylbutadiene; pentadiene; and combinations thereof. In another embodiment, the diolefin monomer is an alicyclic compound. Non-limiting examples of suitable alicyclic compounds include: norbornadiene and alkyl derivatives thereof; 5-alkylidene-2-norbornene; 5-alkenyl-2-norbornene; 5-methylene-2-norbornene; 5-ethylidene-2-norbornene; 5-propenyl-2-norbornene; 1,4-cyclohexadiene; 1,5-cyclooctadiene; 1,5-cyclododecadiene; methyltetrahydroindene; dicyclopentadiene; bicyclo [2.2.1]hepta-2,5-diene; and combinations thereof. Preferred diolefin monomers include isoprene and 2-chloro-1,3-butadiene. Of course it is possible to utilize mixtures of the various types of olefin monomers described hereinabove.

In an embodiment, the olefin is a mixture of isobutylene and at least one diolefin monomer. A preferred such monomer mixture comprises isobutylene and isoprene. In this embodiment, it is preferred to incorporate into the preferred mixture of isobutylene and isoprene from about 0.5 to about 7, more preferably from about 1 to about 3 mole percent of the diolefin monomer.

In an embodiment, the olefin is a mixture of isobutylene and at least one α-olefin. A preferred such monomer mixture comprises isobutylene and para-methylstyrene. In this embodiment, it is preferred to incorporate into the mixture of isobutylene and para-methylstyrene from about 0.5 to about 3, more preferably from about 1 to about 2 mole percent of the α-olefin monomer.

As one of skill in the art of the invention will recognize, the number of halogen-comprising electrophilic groups per polymer chain will affect the maximum concentration of ionic functionality within an azolium ionomer. Typically, the electrophile content of a halogenated polymer is from about 0.1 to about 100 groups per 1000 polymer backbone carbons. In some cases, electrophile content is between 5 and 50 groups per 1000 polymer backbone carbons.

Selection of a halogenated electrophile is within the purview of a person skilled in the art, and can be made from a group consisting of alkyl halide, allylic halide and benzylic halide, and combinations thereof. Non-limiting, generic structures for these examples are illustrated below, where X represents a halogen and R¹-R⁵ are independently hydrogen or aliphatic groups that may bear functionality.

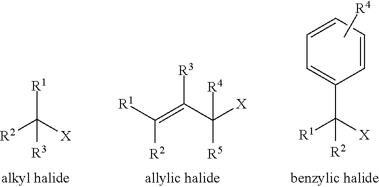

In another embodiment, a halogenated polymer comprises a random distribution of isobutylene mers, isoprene mers and allylic halide electrophiles

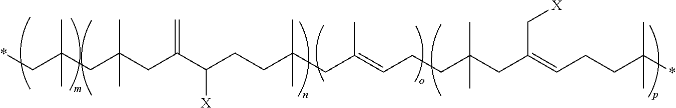

where X is a halogen, including bromine, chlorine and iodine, and combinations thereof. Polymers comprised of about 90-98 mole % isobutylene mers, 1-7 mole % isoprene mers, and 1-3 mole % allylic halide mers are known as halogenated butyl rubber. This includes halogenated polymers derived from “high isoprene” grades of butyl rubber that have greater isoprene contents than conventional butyl rubber materials.

In another embodiment, the halogenated polymer comprises a random distribution of isobutylene mers, para-methylstyrene mers and a benzylic halide electrophile

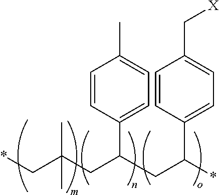

where X is a halo group where preferred halogens include bromine and chlorine, and combinations thereof. Polymers comprised of about 94-97 mole % isobutylene mers, 1-3 mole % para-methylstyrene mers, and 1-3 mole % benzylic bromide mers are known as BIMS.

In an embodiment, the halogenated polymer comprises a random distribution of 2-chloro-1,3-butadiene mers and allylic halide electrophiles.

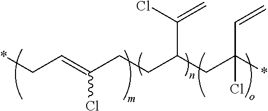

This polymer is commonly known as polychloroprene.

In an embodiment, the halogenated polymer comprises a random distribution of ethylene mers, propylene mers and alkyl halide electrophiles

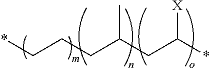

where X is a halo group where preferred halogens include bromine and chlorine, and combinations thereof.

Preferably the halogenated polymers used in the present invention have a molecular weight (Mn) in the range from about 4,000 to about 500,000, more preferably from about 10,000 to about 200,000. It will be understood by those of skill in the art that reference to molecular weight refers to a population of polymer molecules and not necessarily to a single or particular polymer molecule.

### Cross-Linking Nucleophile

As defined above, the term “azole” is a cyclic five-membered heteroaromatic compound having at least one nitrogen atom in the azole ring and at least one other non-carbon ring atom of either nitrogen, sulfur, or oxygen. In certain embodiments of the invention, an azole is a compound of formula (1) shown below which includes an imidazole moiety:

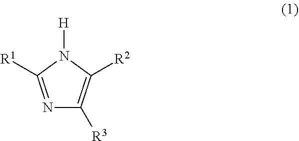

where R¹, R² and R³ are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally, any combination of R¹, R² and R³ together with the azole ring atoms to which they are bonded form a cyclic structure.

Non-limiting examples of compounds of formula (1) include: imidazole, 2-methylimidazole, and benzimidazole, whose structures are illustrated below, respectively:

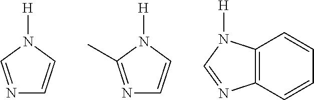

In certain embodiments of the invention, the cross-linking nucleophile is a compound of formula (2) shown below which includes an pyrazole moiety:

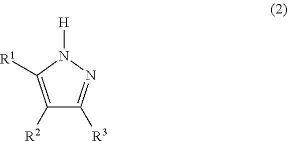

where R¹, R² and R³ are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally, any combination of R¹, R² and R³ together with the azole ring atoms to which they are bonded form a cyclic structure.

Non-limiting examples of compounds of formula (2) include: pyrazole and benzopyrazole, whose structures are illustrated below, respectively:

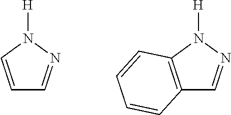

In an embodiment of the invention, the cross-linking nucleophile is a 1,2,3-triazole of formula (3), as illustrated below.

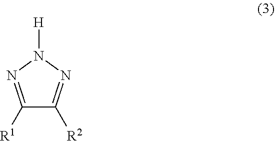

where R¹ and R² are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally, R¹ and R² together with the azole ring atoms to which they are bonded form a cyclic structure.

In an embodiment of the invention, the cross-linking nucleophile is a 1,2,4-triazole of formula (4), as illustrated below.

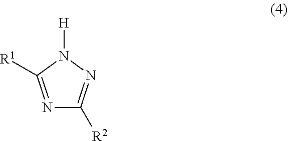

where R¹ and R² are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally, R¹ and R² together with the azole ring atoms to which they are bonded form a cyclic structure.

In an embodiment of the invention, the cross-linking nucleophile is a compound of formula (5) that includes multiple azole moieties.

(Azole)ₙ-Y (5)

where “Azole” is an imidazole, a pyrazole, an oxazole, a thiazole, a triazole or mixtures thereof; and

n is an integer ranging from 2-300; and

Y is a linker.

In certain embodiments, there is no linker, but rather two or more azoles are covalently bonded directly. In some embodiments, the link is a large aryl moiety (e.g., fused aryl rings) substituted with a plurality of azoles.

In a preferred embodiment, the cross-linking nucleophile of formula (5) includes two imidazole moieties linked by an aliphatic group. A non-limiting example includes 1,1′(1,4-butanediyl)bis(imidazole), whose structure is illustrated below.

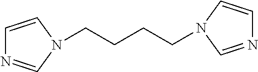

In another embodiment, a cross-linking nucleophile of formula (5) includes a plurality of imidazole moieties bound to a polymer backbone, such as the following: (Azole)ₙ-Y where n and Y are as defined above. In this instance, Y is bonded to a plurality of azole moieties. A non-limiting example includes a copolymer comprising isobutylene mers and imidazole-bearing mers illustrated below.

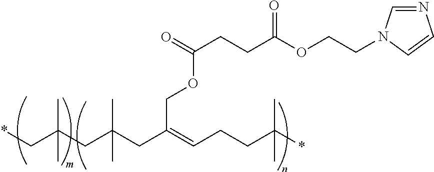

As those with skill in the art of the invention will recognize, such a cross-linking nucleophile ionomer may have many pendant azole groups. Accordingly, for clarity in the discussion herein, a singular pendant group may be described to represent a plurality of pendant azole nucleophiles.

In another embodiment of the invention, a cross-linking nucleophile is a compound of formula (6) that includes a plurality of phosphine moieties

(R₁R₂P)ₙ—Y (6)

where R₁ and R₂ are independently substituted or unsubstituted aryl groups, a substituted or unsubstituted aliphatic groups, or a combination thereof, and optionally bear a functionality;

n is an integer ranging from 2-10; and

Y is a linking moiety.

In some embodiments, n is an integer ranging from 2-5. In certain embodiments, the linker is a C₁-C₁₆ aliphatic moiety. In some embodiments, the link is a large aryl moiety (e.g., fused aryl rings) substituted with a plurality of phosphine moieties.

In an embodiment, a cross-linking nucleophile of formula (6) includes two diaryl phosphine moieties linked by an aliphatic group. Non-limiting examples include 1,2-bis(diphenylphosphino)ethane and 1,6-bis(diphenylphosphino)hexane, whose structures are illustrated below, respectively.

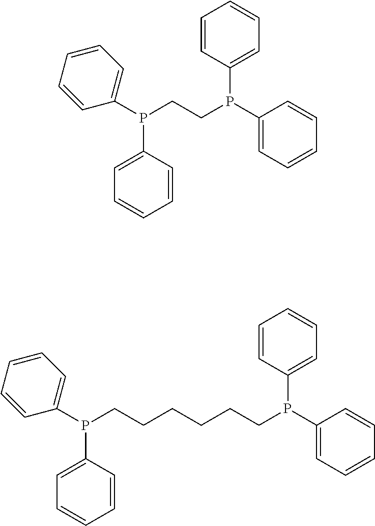

Provision of filler such as carbon black, precipitated silica, talc, clay, glass fibres, polymeric fibres, crystalline organic compounds, finely divided minerals and finely divided inorganic materials can improve the physical properties of polymers. Typically, the amount of filler is between 10 wt % and 60 wt %. Preferably, filler content is between 20 and 45 wt %.

Suitable fillers for use in the present invention are comprised of particles of a mineral, such as, for example, silica, silicates, clay (such as bentonite), gypsum, alumina, titanium dioxide, talc and the like, as well as mixtures thereof. Further examples of suitable fillers include:
highly dispersable silicas, prepared e.g. by the precipitation of silicate solutions or the flame hydrolysis of silicon halides, with specific surface areas of 5 to 1000, preferably 20 to 400 m²/g (BET specific surface area), and with primary particle sizes of 10 to 400 nm; the silicas can optionally also be present as mixed oxides with other metal oxides such as Al, Mg, Ca, Ba, Zn, Zr and Ti;
synthetic silicates, such as aluminum silicate and alkaline earth metal silicate;
magnesium silicate or calcium silicate, with BET specific surface areas of 20 to 400 m²/g and primary particle diameters of 10 to 400 nm;
natural silicates, such as kaolin and other naturally occurring silica;
natural clays, such as montmorillonite, and their ion-exchanged derivatives such as tetraalkylammonium ion exchanged clays;
glass fibers and glass fiber products (matting, extrudates) or glass microspheres;
metal oxides, such as zinc oxide, calcium oxide, magnesium oxide and aluminum oxide;
metal carbonates, such as magnesium carbonate, calcium carbonate and zinc carbonate;
metal hydroxides, e.g. aluminum hydroxide and magnesium hydroxide, or combinations thereof.

Mineral fillers, as described hereinabove, can also be used alone or in combination with known non-mineral fillers, such as:
carbon blacks; suitable carbon blacks are preferably prepared by the lamp black, furnace black or gas black process and have BET specific surface areas of 20 to 200 m²/g, for example, SAF, ISAF, HAF, FEF or GPF carbon blacks;
nano-crystalline cellulose and its surface modified derivatives;
rubber gels, preferably those based on polybutadiene, butadiene/styrene copolymers, butadiene/acrylonitrile copolymers and polychloroprene.

Provision of nano-scale filler such as exfoliated clay platelets, sub-micron particles of carbon black, and sub-micron particles of siliceous fillers such as silica can improve the physical properties of polymers, in particular the impermeability, stiffness and abrasion resistance of the material. Typically, the amount of nano-scale filler is between 0.5 wt % and 30 wt %. Preferably, nano-scale filler content is from about 2 to about 10 wt %.

In certain embodiments of the invention, fillers, as described hereinabove, are included during the preparation processes of ionomer. The method of dispersing filler into the mixture of halogenated polymer and crosslinking nucleophile is not particularly restricted, and selection of an appropriate mixing device is within the purview of one that is skilled in the art. Typically, the amount of filler added to the formulation ranges from 2-60 percent of the total mixture weight. More preferably, the filler content is between 4 and 35 wt %.

In certain embodiments of the invention, additives known to those skilled in the art of the invention are included in the ionomer preparation process to improve material properties. For example, provision of antioxidants such as phenolics and amines can improve the oxidative stability of the material. Although not intended to be limiting, the inventors suggest that typical antioxidant amounts are 10-1000 ppm. Anti-ozone and UV-stabilizing compounds can be added to improve weathering characteristics. The provision of process aids such as tackifiers, waxes, oils and soaps can improve the processing properties and cost of a polymer formulation.

In an embodiment, cured ionomers provide enhanced adhesion. Adhesion of a polymer to solid surfaces is an important physical property that leads to formation of composite materials. However, owing to their low surface energies, most polyolefins exhibit only moderate adhesion to glass, mylar, plastic, mineral, metal and ceramic surfaces and, as a result, have deficiencies when used in composite applications. Introduction of ionic functionality to a polymer composition is expected to improve adhesive properties over its non-ionic parent material, owing to the strength of ion-dipole interactions between ionomers and solid surfaces.

### Method of Preparation of Thermoset Ionomer

An aspect of the invention provides a method of making thermoset ionomers by mixing a halogenated polymer and a cross-linking nucleophile, optionally in the presence of other additives. Mixing can be effected using standard polymer processing equipment such as an internal mixer, a two-roll mill, an extruder, and the like. During the mixing process, some heat is generated. However, when thorough crosslinking is desired, additional heat may be added. Accordingly, the resulting mixture is formed into a desired shape, and heated to a temperature sufficient to bring about a substantial amount of cross-linking reactions. The shaping and curing steps may be sequential, as in extrusion and calendaring, or may be concurrent, as in compression molding and injection molding.

Given that synthesis of thermoset ionomers involves nucleophlilic displacement of halogen from halogenated polymer, the amount of cross-linking nucleophile used relative to the amount of halogen affects the extent of polymer functionalization. Typically, the molar ratio of cross-linking nucleophile to halogen is from about 0.1:1 to about 2:1. More preferably, the molar ratio of cross-linking nucleophile to halogen is from about 0.3:1 to about 0.8:1.

The rate at which such a mixture cross-links is dependent on cure temperature, and the method of the present invention is generally carried out from about 70° C. to about 220° C., more preferably from about 110° C. to about 190° C.

### Other Additives

As described above, optionally, mixing is conducted in the presence of other additives. In some embodiments, an acid scavenger is included during the mixing step of the thermoset ionomer preparation described above. Suitable acid scavengers are not particularly restricted, and may include epoxides, non-nucleophilic organic bases, inorganic bases, or a combination thereof. Non-limiting examples include epoxidized soy-bean oil, 1,8-bis(dimethylamino)naphthalene, alkali metal hydroxides such as KOH and NaOH, alkaline earth metal hydroxides, oxides and carboxylates such as Ca(OH)₂, MgO, and Ca(Stearate)₂, zinc salts such as ZnO, phosphorous-comprising oxides, and the like. The molar ratio of acid scavenger relative to the amount of electrophilic halogen in the formulation is from about 0.1:1 to about 2:1. More preferably, the molar ratio of acid scavenger to halogen is from about 0.3:1 to about 0.8:1.

In certain embodiments of the invention, fillers, as described hereinabove, are included during the thermoset ionomer preparation process. Methods of dispersing filler into the uncured formulation is not particularly restricted, and selection of an appropriate mixing device is within the purview of one that is skilled in the art. Typically, the amount of filler used ranges from 2-60 percent of the total mixture weight. More preferably, the filler content is between 4 and 35 wt %.

In certain embodiments of the invention, additives known to those skilled in the art of the invention are included in the thermoset ionomer preparation process to improve material properties. For example, provision of antioxidants such as phenolics and amines can improve the oxidative stability of the material, while anti-ozone and UV-stabilizing compounds can be added to improve weathering characteristics. The provision of process aids such as tackifiers, waxes, oils and metal soaps can improve the processing properties and cost of a polymer formulation.

In other embodiments, polymers that do not include halogen electrophiles are included during the mixing step to yield a polymer blend. The resulting blend is formed into the desired shape, and heated to a cure temperature sufficient to bring about cross-linking. The non-electrophilic polymer may remain uncross-linked, such as is commonplace for thermoplastic vulcanizates, or TPV's, or it may be cross-linked using a formulation that is appropriate for its composition.

### Thermoset Ionomers

An aspect of the present invention provides a thermoset ionomer comprising a network of polymer backbone chains that are covalently bound to each other by a plurality of pendant azolium cations. There are a plurality of anions associated with the plurality of azolium cations forming ion pairs with a general formula 7:

Polymer-crosslinking cationic moiety-Polymer anionic counterion(s) (7)

where “crosslinking cationic moiety” represents a polymer-bound cationic moiety, “anionic counterion(s)” represents an appropriate number of associated anions to balance the charge of the crosslinking cationic moiety, and “Polymer” is a macromolecule to which the cation is covalently attached. As those with skill in the art of the invention will recognize, a thermoset ionomer may have many pendant groups and therefore many crosslinking cationic moieties. Accordingly, for clarity in the discussion herein, a singular pendant group may be described to represent a plurality of pendant cations and associated anions.

Anions associated with cross-linking cations, depicted as “anionic counterion(s)” in formula (7), are not particularly restricted, and comprise one or more of halide, carboxylate, persulfate, sulfate, sulfonate, borate, phosphate, phosphonate or phosphinate, and may bear functionality.

The macromolecules to which the cation is bound, depicted as “Polymer” in formula (7), are not particularly restricted, and can comprise any polymerized olefin monomer and halogenated electrophile, as defined hereinabove, and may bear functionality. In a preferred embodiment, the macromolecule comprises a random distribution of isobutylene mers, isoprene mers and residual allylic halide electrophiles. Non-limiting examples of macromolecule include those derived from the alkylation of nucleophiles by BIIR and CIIR.

In an embodiment, the macromolecular substitutent comprises a random distribution of isobutylene mers, para-methylstyrene mers and residual benzylic halide electrophiles. A non-limiting example of this macromolecular substituent includes that derived from the alkylation of nucleophiles by BIMS.

In an embodiment, the macromolecular substitutent comprises a random distribution of 2-chloro-1,3-butadiene mers and allylic halide electrophiles. A non-limiting example of this macromolecular substituent includes that derived from the alkylation of nucleophiles by polychloroprene.

In another embodiment, the macromolecular substitutent comprises a random distribution of ethylene mers, propylene mers and halogen electrophiles. Non-limiting examples of this macromolecular substituent include those derived from the alkylation of nucleophiles by halogenated poly(ethylene-co-propylene) copolymers and halogenated poly(ethylene-co-propylene-co-ethylidene norbornadiene) terpolymers.

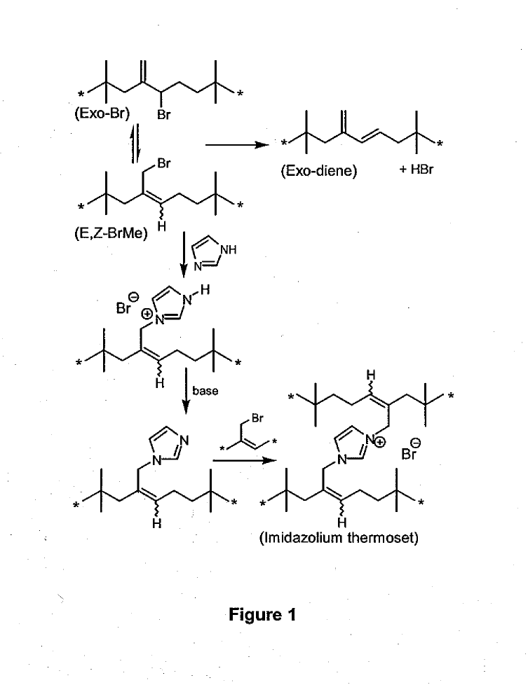

In certain embodiments, polymer-bound azolium cations, are imidazoles, pyrazoles, triazoles, or a combination thereof. These azolium cations are covalently bound by N-alkylation of the corresponding azoles. For example, the azolium cation illustrated in FIG. 1 is covalently bound by N-alkylation at positions 1 and 3 of the imidazole ring.

In an embodiment of the invention, the thermoset ionomer is a compound of formula (8) shown below which includes an imidazolium cation:

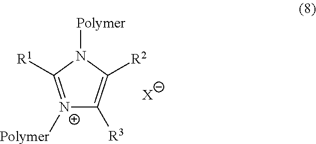

where R¹, R² and R³ are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally, any combination of R¹, R² and R³ together with the azole ring atoms to which they are bonded form a cyclic structure.

In an embodiment of the invention, the thermoset ionomer is a compound of formula (9) shown below which includes a pyrazolium cation:

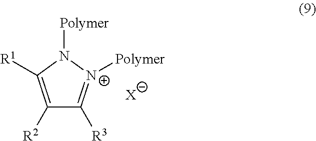

where R¹, R² and R³ are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally any combination of R¹, R² and R³ together with the azole ring atoms to which they are bonded form a cyclic structure.

In certain embodiments of the invention, the thermoset ionomer is a compound of formula (10), known as a triazolium cation, with three nitrogen atoms at the 1,2,3-positions of the heteroaromatic ring, as illustrated below:

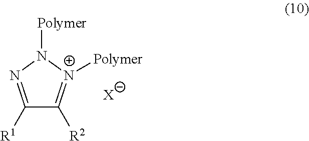

where R¹ and R² are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally, R¹ and R² together with the azole ring atoms to which they are bonded form a cyclic structure.

In certain embodiments of the invention, the thermoset ionomer is a compound of formula (11), known as a triazolium cation, with three nitrogen atoms at the 1,2,4-positions of the heteroaromatic ring, as illustrated below:

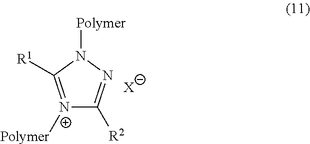

where R¹ and R² are independently hydrogen, silane, a substituted or unsubstituted C₁ to about C₁₆ aliphatic group, a substituted or unsubstituted C₁ to about C₁₆ aryl, or a combination thereof, and optionally bear a functionality; and

optionally, R¹ and R² together with the azole ring atoms to which they are bonded, form a cyclic structure.

In an embodiment of the invention, the thermoset ionomer is a compound of formula (12) that includes multiple azolium moieties

(Polymer-Azolium)ₙ-Y (12)

where “Azolium” is an imidazolium, a pyrazolium, an oxazolium, a thiazoliuim, a triazolium or a combination thereof; and

X⁻ is a non-covalently bound anion associated with the azolium cation;

n is an integer ranging from 2-300; and

Y is a linker.

In certain embodiments, there is no linker, but rather two or more azolium cations are covalently bonded directly. In some embodiments, the link is a large aryl moiety (e.g., fused aryl rings) substituted with a plurality of azolium cations.

In a preferred embodiment, the thermoset ionomer of formula (12) includes two imidazolium moieties linked by an aliphatic group. A non-limiting example includes bisalkylated-1,1′(1,4-butanediyl)bis(imidazole), whose structure is illustrated below.

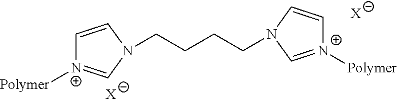

In another embodiment, the thermoset ionomer of formula (12) includes a plurality of imidazole moieties bound to a polymer backbone, such as the following: (Azolium)ₙ-Y where n and Y are as defined above. In this instance, Y has a plurality of azolium moieties associated with it. A non-limiting example includes a copolymer comprising isobutylene mers and imidazolium-bearing mers illustrated below.

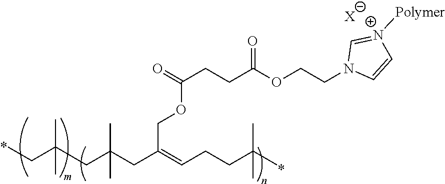

As those with skill in the art of the invention will recognize, such a cross-linking nucleophile ionomer may have many pendant azole groups. Accordingly, for clarity in the discussion herein, a singular pendant group may be described to represent a plurality of pendant azole nucleophiles.

In another embodiment of the invention, the thermoset ionomoer is a compound of formula (13) that includes a plurality of phosphonium moieties

(Polymer-Phosphonium)ₙ-Y(X⁻)ₙ (13)

where “Phosphonium” is a quaternary phosphonium cation;

X⁻ is a non-covalently bound anion associated with the azolium cation;

n is an integer ranging from 2-10; and

Y is a linking moiety.

In some embodiments, n is an integer ranging from 2-5. In certain embodiments, the linker is a C1-C16 aliphatic moiety. In some embodiments, the link is a large aryl moiety (e.g., fused aryl rings) substituted with a plurality of phosphonium moieties.

In an embodiment, the thermoset ionomer of formula (13) includes two diaryl phosphonium moieties linked by an aliphatic group. A non-limiting example includes bisalkylated 1,2-bis(diphenylphosphino)ethane, whose structure is illustrated below.

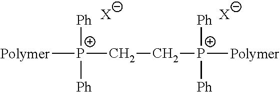

Detailed methods for making such thermoset ionomers are described hereinabove and in the working examples. Details regarding their properties are described herein and shown in the Figures.

In an embodiment, thermoset ionomer provides enhanced adhesion. Adhesion of a polymer to solid surfaces is an important physical property that leads to formation of composite materials. However, owing to their low surface energies, most polyolefins exhibit only moderate adhesion to glass, mylar, plastic, mineral, metal and ceramic surfaces and, as a result, have deficiencies when used in composite applications. Introduction of ionic functionality to polymer composition through nucleophilic displacement of halide by a cross-linking nucleophile is expected to improve adhesive properties over its non-ionic parent material, owing to the strength of ion-dipole interactions between ionomers and solid surfaces.

In another embodiment, the thermoset ionomer according to the present invention enhances the properties of a polymer blend. Thermoplastic vulcanizates, commonly known as TPV's, utilize mixtures of semi-crystalline polymers and thermoset elastomers to provide compositions with exceptional physical properties. Blends of different elastomers are widely used in rubber articles such as tire treads, where optimization of properties such as abrasion resistance, rolling resistance and traction are critical to performance. Thermoset ionomers, as described herein, are cross-linked using reaction conditions similar to those used in existing TPV and elastomer blends, and are therefore expected to be serviceable in these applications.

In another embodiment, the thermoset ionomer according to the present invention provides enhanced mechanical properties. Thermoset materials comprising stable covalent bonds are known to resist deformation and stress relaxation when exposed to static loads, but often respond poorly to dynamic loads. Thermoset ionomers, as described herein, have polymer chain networks comprising covalent bonds and labile ion-pair aggregates. This combination may provide good static properties such as compression set, good dynamic properties such as fatigue to failure, or both. Thus, a thermoset ionomer may provide a unique balance of both static properties such as compression set and dynamic properties such as flex fatigue.

In yet another embodiment of the present invention, thermoset ionomer may reduce a population of and/or prevent accumulation of organisms, including bacteria, algae, fungi, mollusks or arthropods. Although the Applicants do not intend to be bound by theory, it is believed that the ion pairs that are covalently bound to a thermoset ionomer may impart antimicrobial properties that are not observed in typical halogenated polymers. By way of example, the following microorganisms are mentioned without imposing any limitation to the types of microorganism against which a thermoset ionomer are expected to be effective: Gram-negative bacteria—Salmonella, Shigella, Neisseria gonorrhoeae, Neisseria meningitidis, Haemophilus influenzae, Escherichia coli, Klebsiella, Pseudomonas aeruginosa. Gram-positive bacteria—Bacillus, Listeria, Staphylococcus, Streptococcus, Enterococcus, Clostridium, Epulopiscium, Sarcina, Mycoplasma, Spiroplasma, Ureaplasma, Lactobacillus, Corynebacterium, Propionibacterium, Gardnerella, Frankia, Streptomyces, Actinomyces, and Nocardia. Algae: Chlorophyta, Rhodophyta, Glaucophyta, Chlorarachniophytes, Euglenids, Heterokonts, Haptophyta, Cryptomonads, Dinoflagellates. Fungi: Alternaria, Aspergillus, Basidiomycetes, Botrytis, Candida albicans, Cephalosporium, Cheatomium, Cladosporium, Cuvalaria, Drechslera, Epicoccum, Fusarium, Geotrichum, Helminthosporium, Humicola, Monilia, Neuspoa, Nigrospora, Penicillium, Phoma, Pullularia, Rhizophus, Rhodotorula, Scopulariopsis, Stemphylium, Trichoderma, Unocladium and Verticillum.

In an embodiment, the thermoset ionomer according to the present invention possesses superior properties compared to non-ionic thermosets, e.g., sulfur-cured, peroxide-cured or resin-cured polymers. For example, the thermoset ionomer according to the present invention may provide superior adhesion, superior antimicrobial activity, and/or superior mechanical properties, compared to non-ionic thermosets (e.g., sulfur-cured, peroxide-cured or resin-cured). In a particular embodiment, the thermoset ionomer according to the present invention provides both superior static properties such as compression set and superior dynamic properties such as flex fatigue, compared to non-ionic thermosets. In another embodiment, the thermoset ionomer provides superior flex fatigue, Young's modulus, tensile strength and/or mylar adhesion, compared to non-ionic thermosets.

Accordingly, articles made from thermoset ionomers such as, for example, caulking, contact cements, pressure sensitive adhesives, tank liners, membranes, o-rings, tire inner liners, tire treads, TPV's, gaskets, and sealants, can benefit from these qualities. Thermoset ionomers may also find use in applications such as, for example, consumer applications, industrial and medical products and include but are not limited to the following: fuel cell membrane, pharmaceutical stopper, syringe fitting, ion-exchange resin, separation membrane, bathroom safety equipment, garden equipment, spa equipment, water filtration equipment, caulking, sealant, grout, contact cement, adhesive, pressure sensitive adhesive, tank liner, membrane, packaging material, cell culture equipment, light switch, exercise equipment, railing, sports equipment, steering wheel, writing tool, luggage, O-ring, tire inner liner, tire tread, thermoplastic vulcanizate (TPV), gasket, appliance, baby product, bottle, lid, toilet seat, bathroom fixture, flooring, surface including surface for food preparation, utensil, handle, grip, doorknob, container for food storage, gardening tool, kitchen fixture, kitchen product, office product, pet product, water storage equipment, food preparation equipment, shopping cart, surfacing material, storage container including food storage container, footwear, protective wear, sporting gear, cart, dental equipment, door knob, clothing, handheld device, telephone, toy, container for fluid, catheter, keyboard, surface of vessel, surface of pipe, surface of duct, coating, food processing equipment, materials handling equipment (e.g., auger, conveyor belt), biomedical device, filter, additive, computer, dock, drilling platform, ship hull, underwater infrastructure, HVAC equipment, shower wall, shower flooring, implant, medical textile, tissue sealant, tissue adhesive, personal protective equipment, wetsuit, drysuit, respiratory mask, article to minimize biofouling, pacemaker, wound dressing, ice machine, water cooler, fruit juice dispenser, soft drink machine, piping, storage vessel, metering system, valve, fitting, attachment, filter housing, lining, barrier coating, insulation, chemical protective equipment, or biochemical protective equipment.

Aspects of the present invention may be supplied as a kit. In an embodiment of this aspect, the kit includes a first suitable container housing a haloelastomer and second suitable container housing a crosslinking nucleophile (e.g., a phosphine or an azole having at least one protonated nitrogen in the azole ring). The single container should be such that the integrity of its contents is preserved. The user of the kit would then mix the two ingredients until properly ventilated conditions depending on the recommended safety precautions for that particular crosslinking nucleophile. The user applies the mixture of the two components, and optionally other additives (e.g., filler) and applies the polymer to a surface (or form a desired shape) and heats it to a sufficient temperature to complete the crosslinking.

For example, suitable containers include simple bottles that may be fabricated from glass, organic polymers such as polycarbonate, polystyrene, etc., ceramic, metal or any other material typically employed to hold reagents or food that may include foil-lined interiors, such as aluminum foil or an alloy. Other containers include vials, flasks, and syringes. The containers may have two compartments that are separated by a readily removable membrane that upon removal permits the components to mix. Removable membranes may be glass, plastic, rubber, or the like.

Optionally, kits may also include a molded container to house the mixture during the curing process. Such molds may facilitate preparation of cured polymer in convenient or custom shapes.

Kits may also include instruction materials. Instructions may be printed on paper or other substrates, and/or may be supplied as an electronic-readable medium, such as a floppy disc, CD-ROM, DVD-ROM, Zip disc, videotape, audio tape, etc. Detailed instructions may not be physically associated with the kit; instead, a user may be directed to an internet web site specified by the manufacturer or distributor of the kit, or supplied as electronic mail.

The following working examples further illustrate the present invention and are not intended to be limiting in any respect.

### WORKING EXAMPLES

### Materials and Methods

The following reagents were used as received from Sigma-Aldrich (Oakville, Ontario): 1,2-bis(diphenylphosphino)ethane, 1-butylimidazole (BIM, 98%), 1,4-dibromobutane (99%), imidazole (99%), Proton Sponge (1,8-bis(dimethylamino)naphthalene, 99%), 1-(2-hydroxethyl)-imidazole (97%), KOH (>90%), tricaprylmethylammonium chloride (Aliquat® 336) and succinic anhydride (99+%). Sodium hydroxide (98.1%) was used as received from Fisher Scientific (Fair Lawn, N.J.). Brominated poly(isobutylene-co-isoprene) (BIIR or BB2030, Mₙ=410 000 and polydispersity=1.5) contained 0.15 mmol/g of allylic bromide functionality was used as supplied by LANXESS Inc. (Sarnia, Ontario). Brominated poly(isobutylene-co-paramethylstyrene) (BIMS or Exxpro 3745) containing 0.21 mmol/g benzylic bromide functionality was used as supplied by Exxon Mobil (New Jersey, USA). Hi-Sil 233 (synthetic hydrated amorphous silica) was used as received from PPG Industries (Pittsburgh, Pa.).

The extent of cross-linking as a function of time was monitored through measurements of shear storage modulus (G′) using an Advanced Polymer Analyzer 2000 (Alpha Technologies, Akron, Ohio, USA) operating at an oscillation frequency of 1 Hz and an arc of 3°.

### Example 1

### Preparation of a Thermoset Ionomer from Bromobutylrubber (BIIR) and Imidazole

This example illustrates the synthesis of a thermoset ionomer using imidazole and BIIR. The reaction involves nucleophilic displacement of bromide from BIIR to yield an imidazolium salt, whose deprotonation generates a polymer-bound N-allyl imidazole intermediate. Subsequent alkylation of this intermediate produces bis-alkylated imidazolium bromide salt that serves as a cross-link between polymer chains (see FIG. 1).

BIIR (40 g, 6.0 mmole allylic bromide) was mixed with 0.5 molar equivalents of imidazole (0.204 g, 3.0 mmole) relative to allylic bromide functionality and 0.5 molar equivalents of Proton Sponge (0.64 g, 3.0 mmole) relative to allylic bromide functionality using a Haake Polylab R600 internal batch mixer equipped with Banbury blades and operating at 90° C. and 60 rpm for 5 minutes. This mixing procedure was repeated to prepare three additional compounds comprised of BIIR (40 g)+imidazole (0.4 g, 1 eq)+Proton Sponge (0.64 g, 0.5 eq); BIIR (40 g)+imidazole (0.10 g, 0.25 eq)+Proton Sponge (0.64 g, 0.5 eq); and BIIR (40 g)+imidazole (0.20 g, 0.5 eq)+Proton Sponge (0 g, 0.0 eq).

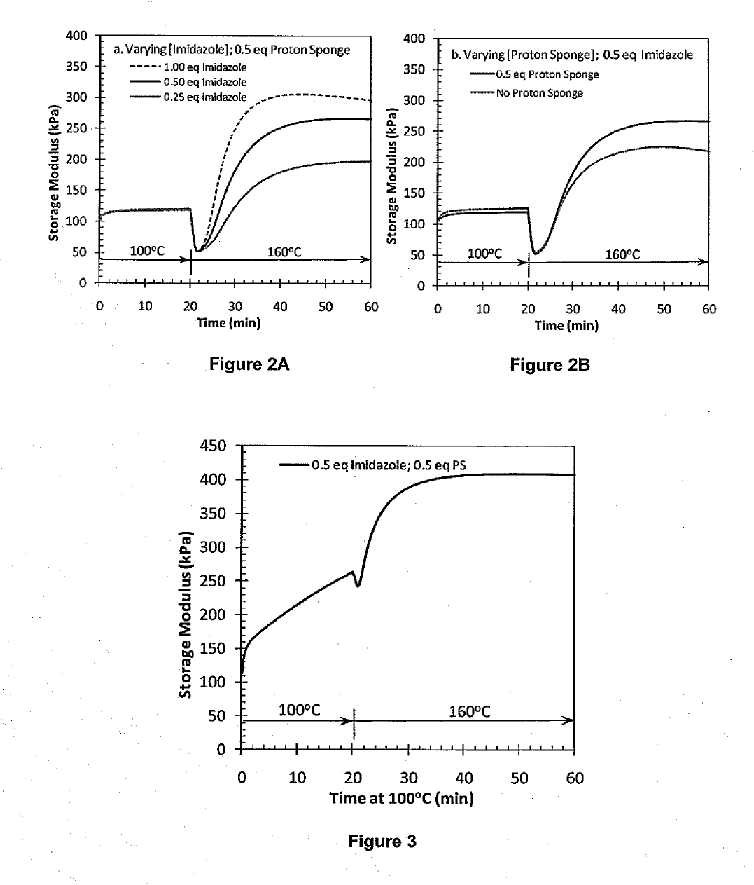

The resulting mixtures were heated in the cavity of a rheometer to 100° C. for 20 minutes, and then to 160° C. for a further 40 minutes. FIG. 2 illustrates the storage modulus of these mixtures as a function of time. Data plotted in FIG. 2a shows that imidazole does not cross-link BIIR significantly over a 20 min period at 100° C., thereby providing a measure of scorch safety. Increasing the temperature to 160° C. resulted in extensive curing, with cross-link densities increasing with imidazole loading.

The data plotted in FIG. 2b show that Proton Sponge is not required to support an efficient imidazole cure of BIIR at 160° C. However, the provision of such a strong non-nucleophilic base such as Proton Sponge has a positive effect on the final state of cure.

A fourth compound was prepared containing precipitated silica as reinforcing filler. BIIR (30 g, 4.5 mmol) was mixed with imidazole (0.153 g, 2.25 mmol), Proton Sponge (0.482 g, 2.25 mmol) and Hi-Sil 233 (9 g) as described above. Curing the compound at 160° C. for 60 min raised the storage modulus from 133 kPa to a maximum value of 299 kPa.

### Example 2

### Preparation of a Thermoset Ionomer from Brominated poly(isobutylene-co-methylstyrene (BIMS) and Imidazole

This example illustrates the synthesis of a thermoset ionomer by reaction of BIMS with imidazole. BIMS (40 g, 8.1 mmole benzylic bromide) was mixed with imidazole (0.276 g, 4.05 mmole) and Proton Sponge (0.868 g, 4.05 mmole) and cured as described in Example 1. Data plotted in FIG. 3 illustrate the efficacy of imidazole in curing a halogenated polymer comprising a multiplicity of benzylic halide electrophile. Significant cure activity was observed at 100° C., and the rate of cure was accelerated at 160° C. toward a final storage modulus of 406 kPa.

### Example 3

### Preparation of a Thermoset Ionomer from Bromobutylrubber (BIIR) and Bisimidazole

This example illustrates the synthesis of a thermoset ionomer by reaction of BIIR with cross-linking nucleophile, 1,1′(1,4-butanediyl)bis(imidazole), comprised of two N-alkyl imidazole moieties linked by a butyl moiety.

An aqueous solution of NaOH (12.50 g) in water (12.50 g) was mixed with toluene (60 mL) prior to the addition of imidazole (1.31 g, 19.8 mmole) and tetrabutylammonium bromide (0.606 g, 1.98 mmol). Once all solids were dissolved, 1,4-dibromobutane (2.02 g, 9.32 mmole) was added to the solution and the mixture was heated to 60° C. for 16 hours. The mixture was cooled to room temperature prior to the addition of water (80 g), whereupon crystals appeared. Solids were then collected by vacuum filtration and dried in a vacuum oven, yielding 1,1′(1,4-butanediyl)bis(imidazole). (1.486 g, 84% yield). ¹H NMR (CDCl₃) δ 1.76 (t, C—CH₂—CH₂—C), 3.93 (m, N—CH₂—C), 6.86 (s), 7.07 (s), 7.44 (s). Melting point=83-86° C.

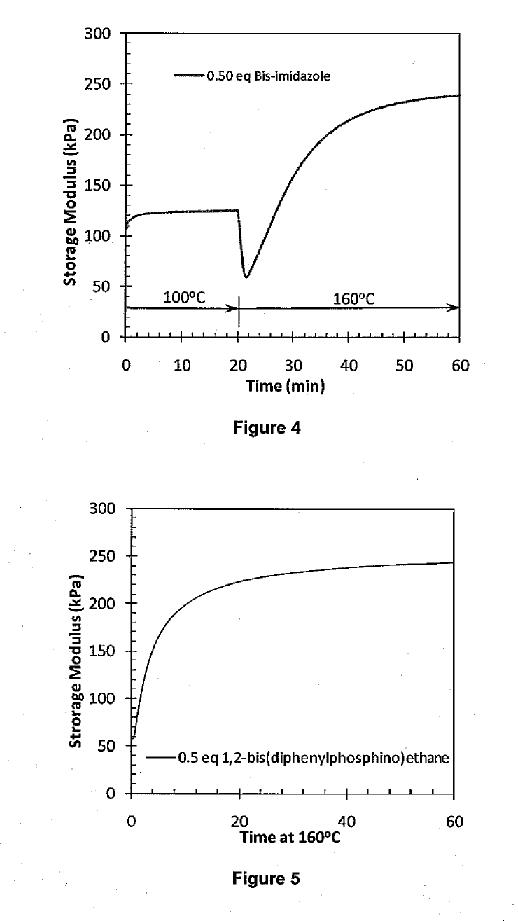

BIIR (40 g, 6.0 mmole allylic bromide) was mixed with 1,1′(1,4-butanediyl)bis(imidazole) (0.58 g, 3.0 mmole) and cured as described in Example 1. Data plotted in FIG. 4 shows that bisimidazole provided good scorch safety over a 20 min period at 100° C., and cross-linked BIIR extensively upon heating to 160° C.

### Example 4

### Preparation of a Thermoset Ionomer from Bromobutylrubber (BIIR) and Bisphosphine

This example illustrates synthesis of a thermoset ionomer by reaction of BIIR with a cross-linking nucleophile, 1,2-bis(diphenylphosphino)ethane, comprised of two phosphine moieties that are attached by an alkyl group. BIIR (40 g, 6.0 mmole allylic bromide) was mixed with 1,2-bis(diphenylphosphino)ethane (1.19 g, 3 mmole) as described in Example 1 and cured in the cavity of a rheometer, as described above. The data plotted in FIG. 5 show that the bisphosphine cross-linked BIIR extensively at 160° C.

### Example 5

### Preparation of a Thermoset Ionomer from Bromobutylrubber (BIIR) and IIR-g-Imidazole

This example illustrates the synthesis of a thermoset ionomer by reaction of BIIR with a polymeric composition comprised of a butyl rubber backbone and a multiplicity of pendant alkylimidazole groups. A solution of 1-(2-hydroxyethyl)imidazole (1.96 g, 0.0178 mol) and succinic anhydride (1.78 g, 0.0178 mol) in THF (20 ml) was heated to reflux for 6 hours. Off-white crystals precipitated out of solution and were collected through gravity filtration and dried, yielding 4-[2-(1H-imidazol-1-yl)ethoxy]-4-oxobutanoic acid. ¹H NMR (D₂O) δ 2.337 (t, —CH₂—CH₂—COOR), 2.49 (t, —CH₂—CH₂—COOH), 4.39 (t, —N—CH₂—CH₂—), 4.44 (t, —N—CH₂—CH₂—O), 7.36 (s, —N—CH═CH—N—R) 7.46 (s, —N—CH═CH—N—R), 8.65 (s, —N═CH—N—). High-resolution MS analysis; required for C₁₀H₁₃N₂O₄ m/z 212.0797. Found m/z 212.0802. Melting point=108-110° C.

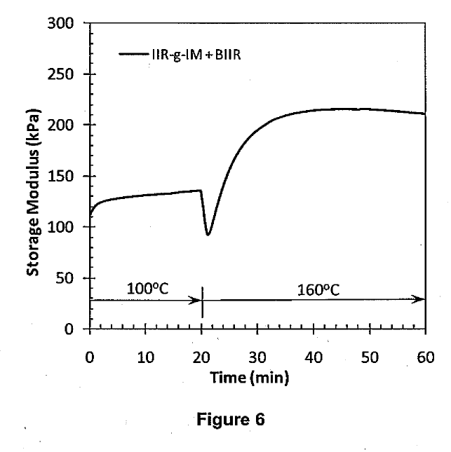

4-[2-(1H-imidazol-1-yl)ethoxy]-4-oxobutanoic acid (0.372 g, 1.76 mmol) was combined with Aliquat 336 (0.710 g, 1.76 mmol) and KOH (0.0704 g, 1.76 mmol) and toluene (5 ml) and mixed for 17 hours at room temperature. The mixture was then added to a solution of BIIR (3.57 g, 0.536 mmol) in toluene (70 g) and heated one hour at 100° C. The solution was cooled to room temperature, yielding a polymer with a multiplicity of N-allyl imidazole functionality pendant off of a butyl rubber backbone. BIIR (3.50 g, 0.530 mmol) was dissolved into this solution, and the mixture of polymers was isolated by precipitation in acetone. The product was re-dissolved in tetrahydrofuran and precipitated in acetone prior to drying under vacuum. The resulting mixture was charged to the cavity of the APA rheometer described above to yield the storage modulus versus time plot provide in FIG. 6. The data illustrate a significant extent of cross-linking, as evidenced by the increase in storage modulus with time.

### Example 6

### Enhanced Adhesion

BIMS (40 g, 8.1 mmole benzylic bromide) is mixed with imidazole (0.276 g, 4.05 mmole) and Proton Sponge (0.868 g, 4.05 mmole) as described in Example 1. The resulting mixture is tested using ASTM standard D413 and D429-08 for adhesion to flexible and rigid substrates, respectively. This material displays enhanced adhesion to metals, ceramics, mylar, plastics, Teflon™ and glass.

### Example 7

### Resistance to Microorganism Growth

BIIR (40 g, 6.0 mmole allylic bromide) is mixed with 1,1′(1,4-butanediyl)bis(imidazole) (0.58 g, 3.0 mmole) in a Haake Polylab internal mixing device and compression molded into a 2 mm thick sheet and cured at 160° C. cured for 30 minutes, yielding a thermoset ionomer. This material displays resistance to the growth of gram positive bacteria, gram negative bacteria, algae and fungi.

### Example 8

### Enhanced Mechanical Properties

This example illustrates the enhanced mechanical properties provided by a thermoset ionomer by comparison to a non-ionic thermoset derived from the same starting material. BIIR (40 g, 6.0 mmole allylic bromide) was mixed with 1,1′(1,4-butanediyl)bis(imidazole) (0.58 g, 3.0 mmole) as described in Example 3. The resulting compound was sheeted with a two-roll mill and compression molded at 160° C. and 20 MPa for 30 min. The sheeted products had a thickness of 2.00±0.05 mm. Tensile strength data were acquired using an INSTRON Series 3360 universal testing instrument, operating at a crosshead speed of 500 mm/min at 23±1° C. Dogbones were cut from the specimen cutter described in ASTM D4482. Four replicate measurements were made for each sample to test the precision of the compounding and physical testing procedures, with data expressed in terms of arithmetic means. Flex fatigue data were acquired by repeated tensile elongation to a fixed strain of 80% at 100 cycles per minute at room temperature, with data reported as the number of strain cycles endured before sample failure. Adhesion samples were prepared by compression molding a mixed compound onto a mylar sheet, and cutting the cured product into 25 mm wide strips. Adhesion between the thermoset ionomer and mylar was determined by the tensile strength measurement described above, with adhesion data reported as the force in Newtons required to pull the mylar away from the thermoset ionomer.

Thermoset ionomer samples for compression set analysis were prepared with a cylindrical mold with a diameter of 14.0 mm and a height of 12.5 mm, operating at 160° C. for 30 min. The final cylinders had a diameter of 14±0.1 mm and a height of 12.5±0.2 mm. compression set measurements were carried out using a pneumatic press. Sample height was measured, and samples, as well as stainless steel spacers, were placed on a stainless steel plate inside the press. The spacer height was 6.44 mm, corresponding to an applied strain of approximately 45%. The apparatus was compressed with 3.5 MPa and left for 22 h. After 22 h, the samples were removed and left to rest for 0.5 h before the final height of the cylinders was measured.

A thermoset material containing no polymer-bound ion pairs was prepared by peroxide-vulcanization of a BIIR-derived macromonomer, IIR-g-dodecyl itaconate, which was prepared as follows. 1-Dodecanol (80.0 mmol, 15 g) and itaconic anhydride (87 mmol, 9.74 g), were dissolved in toluene (50 g) and heated to 80° C. for 4 hr. Residual starting materials and solvent were removed by Kugelrohr distillation (T=80° C., P=0.6 mmHg). The resulting acid-ester, monododecyl itaconate, was isolated and dried. Monododecyl itaconate (7.2 g, 24.3 mmol) was treated with a 1M solution of Bu₄NOH in methanol (24 ml, 24 mmol Bu₄NOH) to yield a Bu₄Ncarboxylate salt, which was isolated by removing methanol under vacuum. BUR (160 g) and Bu₄NBr (7 g, 21.7 mmol) were dissolved in toluene (1450 g) and heated to 85° C. for 180 min. Bu₄Ncarboxylate salt (13.2 g, 24.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-dodecyl itaconate. ¹H-NMR (CDCl₃): δ 6.24 (s, CH₂═C(CH₂)—COO—, 1H), δ 5.62 (s, CH₂═C(CH₂)—COO—, 1H), δ 3.36 (s, CH₂═C(CH₂)—COO—, 2H), δ 4.54 (E-ester, ═CH—CH₂—OCO—, 2H, s), δ 4.60 (Z-ester, ═CH—CH₂—OCO—, 2H, s). This macromonomer was cured by mill mixing with 0.5% dicumyl peroxide before compression molding as described above to give a non-ionic thermoset, which was then subjected to the same compression set, tensile, flex fatigue and mylar adhesion analyses used for the thermoset ionomer.

The data provided in the following table demonstrate that the thermoset ionomer provides comparable compression set performance to the non-ionic thermoset, but provides superior flex fatigue, Young's modulus, tensile strength and mylar adhesion.

| | Thermoset | Non-ionic |
|---|---|---|
| | Ionomer | Thermoset |
| Compression Set (%) | 7 | 5 |
| Flex Fatigue (cycles to failure) | >6000 | 600 |
| Young's Modulus (MPa) | 0.64 | 0.39 |
| Elongation at Break (%) | 870 | 640 |
| Tensile at Break (MPa) | 1.7 | 0.7 |
| Mylar Adhesion (N) | 3.9 | 1.6 |

It will be understood by those skilled in the art that this description is made with reference to certain embodiments and that it is possible to make other embodiments employing the principles of the invention which fall within its spirit and scope as defined by the claims.

1. A thermoset ionomer comprising:
a cross-linked network of polymer chains that are covalently bonded to one another by a plurality of pendant cationic moieties;
wherein the cationic moieties comprise a bis-N-alkylated azolium ion, a moiety comprising a plurality of N-alkylated azolium ions, or a moiety comprising a plurality of P-alkylated phosphonium ions.

2. The thermoset ionomer of claim 1 comprising a crosslinking imidazolium, as in formula (8): 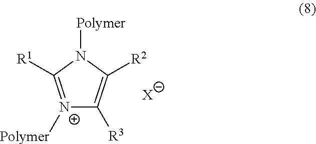
wherein R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality;
optionally, any combination of R¹, R² and R³ together with the azole ring atoms to which they are bonded form a cyclic structure; and
X⁻ is an anion.

3. The thermoset ionomer of claim 2, wherein the imidazolium comprises: imidazolium, 2-methylimidazolium, benzimidazolium, or a combination thereof.

4. The thermoset ionomer of claim 1 comprising a cross-linking pyrazolium, as in formula (9): 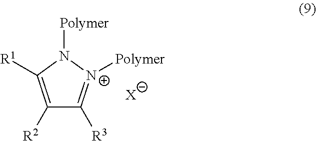
wherein R¹, R² and R³ are independently hydrogen, silane, a substituted or unsubstituted C₁ to about C₁₆ aliphatic group, a substituted or unsubstituted C₁ to about C₁₆ aryl group, or a combination thereof, and optionally bear a functionality;
optionally, any combination of R¹, R² and R³ together with the azole ring atoms to which they are bonded form a cyclic structure; and
X⁻ is an anion.

5. The thermoset ionomer of claim 4, wherein the pyrazolium is pyrazolium, benzopyrazolium, or a combination thereof.

6. The thermoset ionomer of claim 1 comprising a crosslinking 1,2,3-triazolium, as in formula (10): 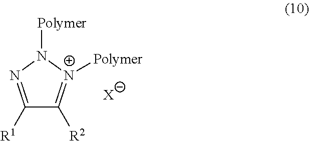
wherein R¹ and R² are independently hydrogen, silane, a substituted or unsubstituted C₁ to about C₁₆ aliphatic group, a substituted or unsubstituted C₁ to about C₁₆ aryl group, or a combination thereof, and optionally bear a functionality;
optionally, R¹ and R² together with the azole ring atoms to which they are bonded form a cyclic structure; and
X⁻ is an anion.

7. The thermoset ionomer of claim 1 comprising a crosslinking 1,2,4-triazolium, as in formula (11): 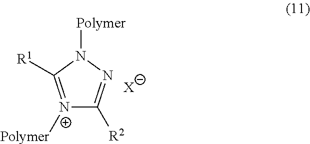
wherein R¹ and R² are independently hydrogen, silane, a substituted or unsubstituted C₁ to about C₁₆ aliphatic group, a substituted or unsubstituted C₁ to about C₁₆ aryl group, or a combination thereof, and optionally bear a functionality;
optionally, R¹ and R² together with the azole ring atoms to which they are bonded form a cyclic structure; and
X⁻ is an anion.

8. The thermoset ionomer of claim 1 comprising a plurality of N-alkylated moieties, as in formula (12):
(Polymer-Azolium)ₙ-Y(X⁻)ₙ (12)
where “azolium” is an imidazolium, a pyrazolium, an oxazolium, a thiazolium, a triazolium, or a combination thereof;
X⁻ is an anion;
n is an integer ranging from 2-300; and
Y is a linker.

9. The thermoset ionomer of claim 8, wherein the Y is an aliphatic linker.

10. The thermoset ionomer of claim 9 wherein the azolium is bis-alkylated 1,1′(1,4-butanediyl)bis(imidazole), as shown below:

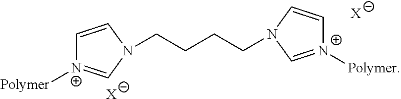

11. The thermoset ionomer of claim 8, wherein the cationic moiety comprises a plurality of imidazolium moieties bound to a polymer backbone.

12. The thermoset ionomer of claim 11, wherein the thermoset polymer is a crosslinked network of isobutylene mers and imidazole-bearing mers, as shown below:

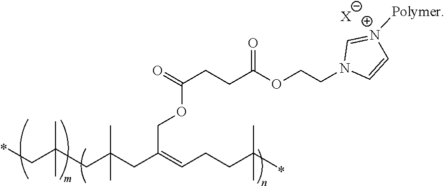

13. The thermoset ionomer of claim 1 comprising a plurality of alkylated moieties, as in formula (13):
(Polymer-Phosphonium)ₙ-Y(X⁻)ₙ (13)
where phosphonium is a quaternary phosphonium cation;
n is an integer ranging from 2-10; and
Y is a linker.

14. The thermoset ionomer of claim 13, wherein Y is aliphatic.

15. The thermoset ionomer of claim 14, wherein the phosphonium moieties are substituted.

16. The thermoset ionomer of claim 15, wherein the substituents are aliphatic, aryl, or a combination thereof.

17. The thermoset ionomer of claim 16, wherein the cationic moieties comprise two diaryl phosphonium moieties linked by an aliphatic group.

18. The thermoset ionomer of claim 17 wherein the cationic moiety comprises bis-alkylated1,2-bis(diphenylphosphino)ethane, as shown below:

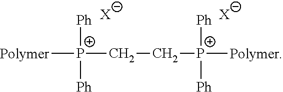

19. The thermoset ionomer of claim 1, wherein the thermoset ionomer provides superior adhesion relative to a non-ionic analogue of the polymer.

20. The thermoset ionomer of claim 19, wherein the thermoset ionomer provides superior adhesion to glass, mylar, plastic, mineral, metal, ceramic, or a combination thereof.

21. The thermoset ionomer of claim 1, wherein the thermoset ionomer reduces a population of organisms or prevents accumulation of organisms (e.g., bacteria, algae, fungi, mollusks, arthropods).

22-23. (canceled)

24. The thermoset ionomer of claim 21, wherein the organisms comprise Gram-negative bacteria or Gram-positive bacteria.

25. A method of making thermoset ionomer, comprising:
mixing halogenated polymer and a cross-linking nucleophile, and heating the mixture to effect cross-linking,
wherein the cross-linking nucleophile comprises an un-N-alkylated azole, a moiety comprising a plurality of un-N-alkylated azoles, or a moiety comprising a plurality of phosphines.

26-59. (canceled)

60. An article comprising a thermoset ionomer of claim 1.

61-66. (canceled)

67. The article of claim 60, wherein the article is fuel cell membrane, pharmaceutical stopper, syringe fitting, ion-exchange resin, separation membrane, bathroom safety equipment, garden equipment, spa equipment, water filtration equipment, caulking, sealant, grout, contact cement, adhesive, pressure sensitive adhesive, tank liner, membrane, packaging material, cell culture equipment, light switch, exercise equipment, railing, sports equipment, steering wheel, writing tool, luggage, o-ring, tire inner liner, tire tread, thermoplastic vulcanizate (TPV), gasket, appliance, baby product, bottle, lid, toilet seat, bathroom fixture, flooring, surface, surface for food preparation, utensil, handle, grip, doorknob, container for food storage, gardening tool, kitchen fixture, kitchen product, office product, pet product, water storage equipment, food preparation equipment, shopping cart, surfacing material, storage container including food storage container, footwear, protective wear, sporting gear, cart, dental equipment, door knob, clothing, handheld device, telephone, toy, container for fluid, catheter, keyboard, surface of vessel, surface of pipe, surface of duct, coating, food processing equipment, materials handling equipment, auger, conveyor belt, biomedical device, filter, additive, computer, dock, drilling platform, ship hull, underwater infrastructure, HVAC equipment, shower wall, shower flooring, implant, medical textile, tissue sealant, tissue adhesive, personal protective equipment, wetsuit, drysuit, respiratory mask, article to minimize biofouling, pacemaker, wound dressing, ice machine, water cooler, fruit juice dispenser, soft drink machine, piping, storage vessel, metering system, valve, fitting, attachment, filter housing, lining, barrier coating, insulation, chemical protective equipment, or biochemical protective equipment.

68. (canceled)

69. The thermoset ionomer of claim 1, wherein the thermoset ionomer provides superior mechanical properties relative to a non-ionic analogue of the polymer.

70. The thermoset ionomer of claim 1, wherein the thermoset ionomer provides superior static properties, superior dynamic properties, or both superior static properties and superior dynamic properties relative to a non-ionic analogue of the polymer.

71. (canceled)

72. The thermoset ionomer of claim 70, wherein the static property is compression set resistance and/or the dynamic property is flex fatigue.

73-78. (canceled)
